(19) United States
(12) Patent Application Publication
(10) Pub. No.: US 2018/0160516 A1
(43) Pub. Date: Jun. 7, 2018

(54) ADAPTIVE CONTROL FOR DISPLAY BACKLIGHT BOOST CONVERTER

(71) Applicant: QUALCOMM Incorporated, San Diego, CA (US)

(72) Inventors: Taewoo KWAK, San Diego, CA (US); Sivaprasad EMBANATH, Singapore (SG)

(21) Appl. No.: 15/601,549

(22) Filed: May 22, 2017

Related U.S. Application Data
(60) Provisional application No. 62/429,561, filed on Dec. 2, 2016.

(51) Int. Cl. H05B 41/282; H05B 33/08; H05B 37/02

(52) U.S. Cl. CPC H05B 41/282; H05B 33/0815; H05B 37/0209; H05B 33/083; H05B 33/0845

(57) ABSTRACT

Liquid crystal display (LCD) backlight boost converters are adaptively controlled, digitally, to achieve improved ripple voltage regardless of independent dimming among light emitting diode (LED) strings. Adaptively controlling an LCD backlight boost converter includes determining, during normal operation, an ongoing current or expected current (e.g., load current) provided to or expected to be provided to one or more of the LED strings by the display backlight boost converters. The controlling of the LCD backlight boost converter further includes adjusting a bandwidth of a boost control loop for controlling the LED backlight boost converter based on the ongoing current or expected current to the LED string(s).

### CROSS-REFERENCE TO RELATED APPLICATION

The present application claims the benefit of U.S. Provisional Patent Application No. 62/429,561, filed on Dec. 2, 2016, and titled “ADAPTIVE CONTROL FOR DISPLAY BACKLIGHT BOOST CONVERTER,” the disclosure of which is expressly incorporated by reference herein in its entirety.

### TECHNICAL FIELD

The present disclosure generally relates to power management integrated circuits (PMICs). More specifically, aspects of the present disclosure relate to boost converter topologies to adaptively control backlight boost converters.

### BACKGROUND

Wireless devices, such as smart phones, are increasingly used for a wide variety of tasks, such as making and receiving calls, accessing and sending email, retrieving data, as well as entertainment. These enhanced features consume significant amounts of battery power. Often these phones have improved displays for better viewing experiences.

Future generation batteries are progressing towards a technology (such as silicon anode), which can retain significant usable charge down to 2.5 volts. At low input voltages (Vᵢₙ), conventional boost operation becomes significantly less efficient, and with some topologies boost operation is unable to deliver the desired current.

Driving the need for efficient boost operation is the increasing use of high density displays. These high density displays provide an improved user experience and better viewing, which is especially desirable for some applications. The dominant market segment of these displays use a matrix configuration of light emitting diodes to backlight the display. As the display density increases, there is a direct correlation to the increase in the number of LEDs used for the backlight and consequently an increase in the backlight power consumption. Because an LED, such as a white LED (WLED), typically has an operating voltage of 3V, and several of these LEDs are stacked in a series configuration, the battery voltage is boosted up to power the LED stack. With an increasing number of LEDs in the display, the power consumption of the boost converter becomes a significant portion of the total system power. Run time efficiency and the ability to boost efficiently from very low battery voltages needs to be improved. In addition output ripple improvement is desirable to avoid audible noise or inaccuracy.

### SUMMARY

According to one aspect of the present disclosure, a method of controlling a boost converter includes determining a current to one or more loads from the boost converter. The method also includes adjusting a bandwidth of a boost control loop to control the boost converter based on the current.

According to another aspect of the present disclosure, an apparatus for wireless communication includes means for determining a current to one or more loads from a boost converter. The apparatus may also include means for adjusting a bandwidth of a boost control loop to control the boost converter based on the current.

Another aspect includes an apparatus for wireless communication having a memory and at least one processor coupled to the memory. The processor(s) is configured to determine a current to one or more loads from a boost converter. The processor(s) is also configured to adjust a bandwidth of a boost control loop to control the boost converter based on the current.

Yet another aspect includes a computer program product for wireless communications in a wireless network having a non-transitory computer-readable medium. The computer-readable medium has non-transitory program code recorded thereon which, when executed by the processor(s), causes the processor(s) to determine a current to one or more loads from a boost converter. The program code also causes the processor(s) to adjust a bandwidth of a boost control loop to control the boost converter based at least in part on the current.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 depicts a simplified system for delivering power in a backlight display device according to one aspect of the disclosure.

FIG. 2A depicts a more detailed example of the system according to one aspect of the disclosure.

FIG. 2B illustrates an exemplary backlight display device, in which the system of FIG. 1 or FIG. 2A may be implemented.

FIG. 3 is a schematic diagram of a boost control loop for adaptively controlling a backlight boost converter of a backlight display device according to aspects of the present disclosure.

FIG. 4 is a schematic diagram of another boost control loop for adaptively controlling a backlight boost converter of a backlight display device according to aspects of the present disclosure.

FIG. 5 illustrates an operation mode control device according to an aspect of the present disclosure.

FIG. 6 depicts a simplified flowchart of a method of controlling a boost converter according to one aspect of the present disclosure.

FIGS. 7A, 7B and 7C depict simplified flowcharts of methods of controlling a display backlight boost converter according to aspects of the present disclosure.

FIG. 8 is a block diagram showing an exemplary wireless communication system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR” and the use of the term “or” is intended to represent an “exclusive OR”.

Aspects of the present disclosure are directed to power management integrated circuits (PMICs). For example, the present disclosure relates to liquid crystal display (LCD) backlight boost converters. In one aspect, the LCD backlight boost converters are controlled digitally. For example, the LCD backlight boost converters are adaptively controlled, digitally, to achieve improved efficiency and low output ripple voltage regardless of independent dimming among light emitting diode (LED) strings. Each LED string includes one or more LEDs. When an LCD display includes multiple LEDs, the multiple LEDs may be connected in series. However, the LED strings may be connected in parallel. Although the present description is with respect to LED backlights for LCD display, the concepts apply equally to other types of loads. For ease of illustration, the description is directed to the LED backlight example.

Adaptively controlling the LCD backlight boost converter includes determining, during normal operation, an ongoing current or expected current (e.g., load current) provided to or expected to be provided to one or more of the LED strings by the display backlight boost converters. The ongoing current or expected current may correspond to or is representative of an increased current associated with a dynamically selected increased (or maximum) brightness level for the one or more LED strings. The dynamic selection may be achieved digitally. The controlling of the LCD backlight boost converter further includes adjusting a bandwidth of a boost control loop for controlling the LED backlight boost converter based on the ongoing current or expected current to the LED string(s).

Adjusting the bandwidth of the boost control loop includes adjusting a transconductance value of a transconductance amplifier in the boost control loop based on the dynamically selected increased brightness level. The adjusted transconductance value may be selected based on a lookup table stored in a memory. For example, the lookup table may include brightness levels matched with corresponding transconductance values. The brightness levels may be represented as a percentage of brightness and/or any other representative brightness parameter. For example, a representative brightness parameter (e.g., 4 bits) in the lookup table may be a subset of an actual brightness parameter (e.g., 12 bits). Using a subset of the actual brightness parameter speeds up the bandwidth adjustment process.

After selecting the increased brightness, a boost reference voltage introduced in the boost control loop for controlling the display backlight boost converter is adjusted based on the selected increased brightness level. For example, a boost reference voltage introduced in a boost control loop may be compared to a selected minimum headroom voltage (VLED) associated with one of the LED strings. A control signal resulting from the comparison may be used to achieve a desirable headroom voltage of current sink devices or drivers associated with the LED strings to improve efficiency.

The aspects of the present disclosure may be implemented in the systems and backlight display devices of the following figures.

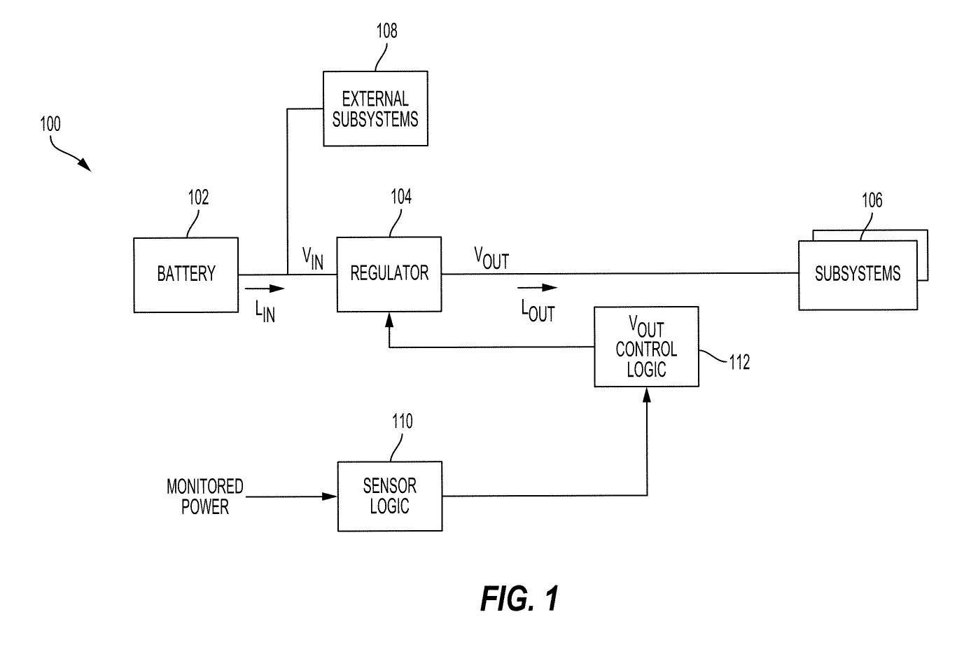

FIG. 1 depicts a simplified system 100 for delivering power in an electronic device (e.g., backlight display device) according to one aspect of the disclosure. The system 100 includes a battery 102 that may provide a power supply voltage from outside a chip including a regulator 104. The regulator 104 may deliver a power supply voltage (e.g., a voltage rail) from a battery 102 to different subsystems 106. Also, other subsystems 108 may be located external to the chip that includes the regulator 104. The subsystems 108 may not draw power from the regulator 104, but may still draw power from the battery 102.

The system 100 may be part of the backlight display device, such as a cellular phone, tablet, or other mobile device. In one aspect, the regulator 104 is highly integrated in the backlight display device with the subsystems 106 and the subsystems 108. In one aspect, the regulator 104 may be a buck regulator, a boost regulator, and/or a buck-or-boost regulator. The regulator 104 regulates the output voltage V_{OUT} from the regulator 104 to different subsystems 106. For example, in the boost mode, the regulator 104 may increase the level of an input voltage V_{IN} that is received from the battery 102. Also, in the buck mode, the regulator 104 may decrease the level of the input voltage V_{IN} that is received from the battery 102.

The system 100 includes various subsystems 106 (e.g., loads or client devices) that draw power from the regulator 104. These subsystems 106 may have different minimum power supply voltage specifications. For example, the minimum operating voltage may be a level below which the subsystems may no longer operate properly. The subsystems 106 may draw different levels of power (e.g., current and/or voltage) at different times depending on the operations the subsystems are performing. Further, different subsystems may draw power at different times, such as a subsystem may draw significant power when actively performing an operation, but not draw a lot of power when idle. For example, a client device such as an electric flash on a camera may draw a large current for a short time when the flash is operated, a WiFi subsystem, a camera sensor, red green blue and white (RGBW) indicators, secure digital (SD)/universal flash storage (UFS), main memory storage, or a cellular subsystem may draw a large current during transmission, or a computer processor may draw a large current while processing a large instruction block.

In a highly-integrated system, such as a mobile phone or tablet computer, the power delivery capability of the regulator 104 is limited by the power available from the battery 102. Under certain conditions, the regulator 104 may not be able to provide sufficient power to meet all the demands of the subsystems 106. When the power specified for multiple subsystems increases past the available power, the power supply voltage at the output of the regulator 104 may droop, causing one or more of the subsystems 106 to fail.

A sensor logic device 110 and a V_{OUT} control logic device 112 adjust the output voltage V_{OUT} such that the regulator 104 is able to provide sufficient power to the subsystems 106. In some implementations, the sensor logic device 110 and the V_{OUT} control logic device may be part of the regulator 104. The sensor logic device 110 monitors power in the backlight display device and uses multiple thresholds to determine when to increase or decrease the output voltage V_{OUT} of the regulator 104. The thresholds may be set below an absolute limit threshold in which the backlight display device may not operate properly if the absolute limit is met. The V_{OUT} control logic device 112 controls the output voltage V_{OUT} by increasing or decreasing the output voltage in increments. The output voltage V_{OUT} may only be decreased to the minimum voltage level or increased to a maximum voltage level. These levels are based on voltage levels requested from a set of the subsystems and priority levels associated with those subsystems.

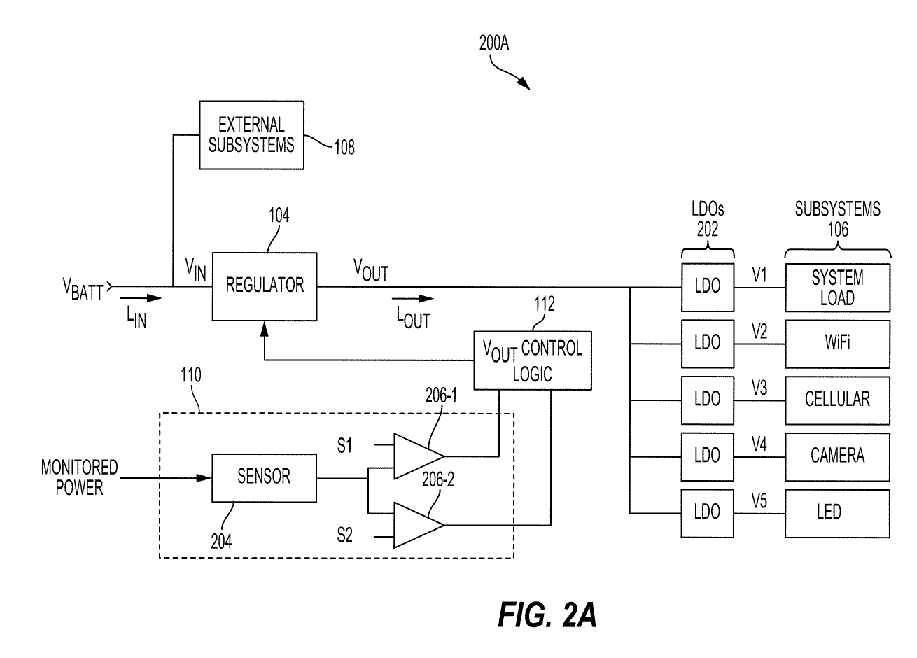

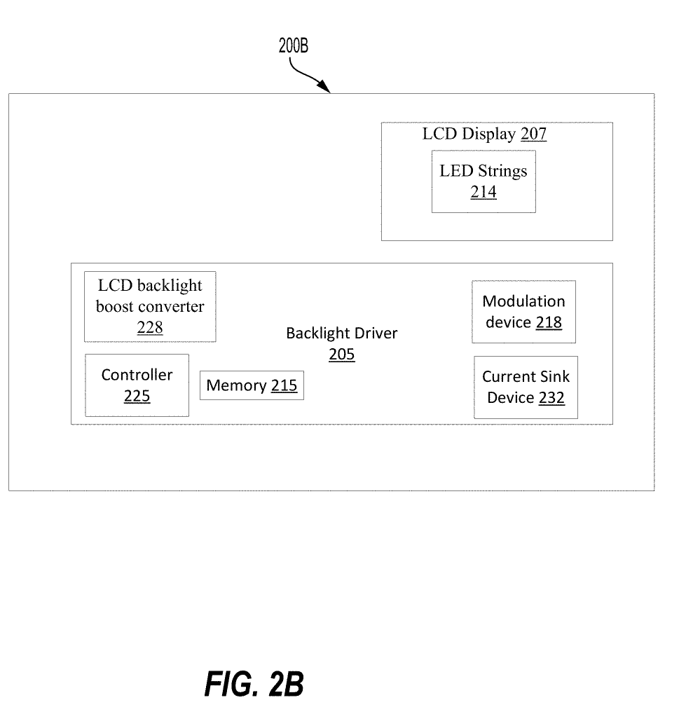

FIG. 2A depicts a more detailed example of the system 200A according to one aspect of the disclosure. In this example, an implementation of the sensor logic device 110 is shown, but it will be recognized that other implementations are possible. For example, the sensor logic device 110 may be implemented in analog circuits, digital circuits, and/or software.

The regulator 104 receives a battery voltage Vbatt (or current Iin) from the battery 102, and provides an output voltage V_{OUT} (or current Iout) to low drop-out (LDO) regulators 202 that customize the internal power supply voltage to each subsystem 106. For example, a system load may specify a voltage V1, a WiFi subsystem may specify a voltage V2, a cellular subsystem may specify a voltage V3, a camera subsystem may specify a voltage V4, and a backlight LED subsystem may specify a voltage V5. These voltages may be the minimum voltage specified for the subsystems to operate properly. For example, if the output voltage dips below this level, a subsystem may experience decreased performance. However, in some cases, the subsystem may not experience a total failure.

Each of these subsystems may be assigned a priority from multiple different priorities. For example, a first higher priority is defined as a “priority level 1” and a second lower priority is defined as a “priority level 0”. The minimum and maximum output voltage V_{OUT} levels of the regulator 104 are generated based on the priorities and the power supply voltages requested by the subsystems 106. For example, a minimum allowable V_{OUT} level is defined by the requested power supply voltages of the subsystems 106 that are designated as “priority level 1”. In one example, the WiFi subsystem may specify 3.6 V to operate properly, but other subsystems 106, such as the system load, may specify only 3.3 V. The WiFi subsystem may be designated as a low priority load and assigned priority level 0 and the system load is designated as a high priority level 1. In this case, during high power loading, it may be acceptable to reduce the power supply output voltage V_{OUT} to be lower than 3.6 V (the level specified by WiFi), but not less than 3.3 V (the level specified by the system load). This reduced voltage may reduce the performance of the WiFi subsystem, but the user impact might be minimal. In this case, as long as the power supply voltage is above 3.3 V, the priority level 1 of the subsystems 106 may operate properly, but the WiFi subsystem may possibly operate at a reduced performance. Because WiFi is considered a lower priority, the reduced performance is tolerated and may not noticeably impact a user of the backlight display device. At the expense of reduced performance of the WiFi subsystem, a shutdown of any subsystem or the entire backlight display device may be avoided.

The sensor logic device 110 includes a sensor 204 that monitors the power from one or more locations in the backlight display device. The locations may be at the input of the regulator 104, the output of the regulator 104, within the regulator 104, the output of the battery 102, and the input of the external subsystems 108. In one aspect, the sensor 204 monitors the input current through the regulator 104, such as through an inductor of the regulator 104. In other examples, either the current or the voltage output by the battery 102 or input to the external subsystems 108 may be monitored.

A comparison logic device shown as a first comparator 206-1 and a second comparator 206-2 receives the monitored power and can compare the monitored power to different thresholds. For example, the first comparator 206-1 compares the power to a first threshold S1 and second comparator 206-2 compares the power to a second threshold S2. The first threshold S1 and the second threshold S2 may be early warning levels that control the automatic adjustment of the output voltage of the regulator 104. A third absolute threshold Lim may be an absolute threshold in which the system may stop operating properly if the power goes above this limit. In this case, the backlight display device or a subsystem may need to be shut down or other undesirable measures taken. In one example, the thresholds may be current thresholds if current is monitored, such as the first threshold S1 is 3.5 A, the second threshold S2 is 3 A, and the absolute threshold Lim may be 4 A. Other thresholds may also be used, such as power or voltage thresholds. That is, the absolute threshold Lim is above the threshold S1, which is above the threshold S2. By providing the other thresholds S1 and S2, the V_{OUT} control logic device 112 may adjust the output voltage V_{OUT} of the regulator 104 such that the threshold Lim may not be reached. This may avoid an undesirable shutdown of components of the backlight display device.

When the monitored power meets the first threshold S1 (is equal to and/or above), the first comparator 206-1 outputs a signal, such as a “high” signal to the V_{OUT} control logic device 112. Also, when the monitored power meets the second threshold S2 (e.g., is equal to or below), the second comparator 206-2 outputs a high signal to the V_{OUT} control logic device 112. Conversely, when the power dips below the first threshold or above the second threshold, comparators 206-1 and 206-2, respectively, output a “low” signal to the V_{OUT} control logic device 112.

When threshold S1 is met, the V_{OUT} control logic device 112 may send a signal to the regulator 104 to step the output voltage V_{OUT} down an increment. The increment may be preset and may be around 32 millivolt (mV)/6 microseconds (μs). When the threshold S2 is met, then the V_{OUT} control logic device 112 may output a signal to the regulator 104 to increase the output voltage by an increment, such as by the same 32 mV/6 us increment. Each time one of the thresholds is met, then the V_{OUT} control logic device 112 may signal the regulator 104 to adjust the output voltage by another increment. In one aspect, once the threshold is hit and goes above or below the threshold, the signal should be cleared before it can be met again. In other aspects, at every clock cycle, the power is checked, and if one of the thresholds is met, the signal is asserted again.

FIG. 2B illustrates an exemplary backlight display device 200B, in which the system of FIG. 1 or FIG. 2A may be implemented. The backlight display device 200B includes an LCD display 207 or other suitable display and a backlight driver 205. The LCD display 207 may include a light source that includes LED strings 214, which provide light to the LCD display 207. Each LED string may include multiple LEDs electrically connected in series. The backlight driver 205 may include a backlight converter 228 (e.g., an LCD backlight boost converter), a controller 225 (e.g., a digital circuit), memory 215, a modulation device 218, and a current sink device 232. The modulation device may be configured to operate in accordance with pulse frequency modulation (PFM), pulse width modulation (PWM), and/or pulse skipping modulation (PSM).

During operation of the backlight display device 200B, the backlight driver 205 may receive or identify brightness level changes (e.g., increase or decrease in desired brightness levels of one or more of the LED strings) and execute one or more instructions in order to generate an output (e.g., a modulation signal) that may be used to drive the LCD display 207. For example, the modulation signal generated based on the brightness levels is forwarded to the LCD backlight boost converter 228. The modulation signal determines an amount of power the LCD backlight boost converter 228 delivers to the LED strings 214.

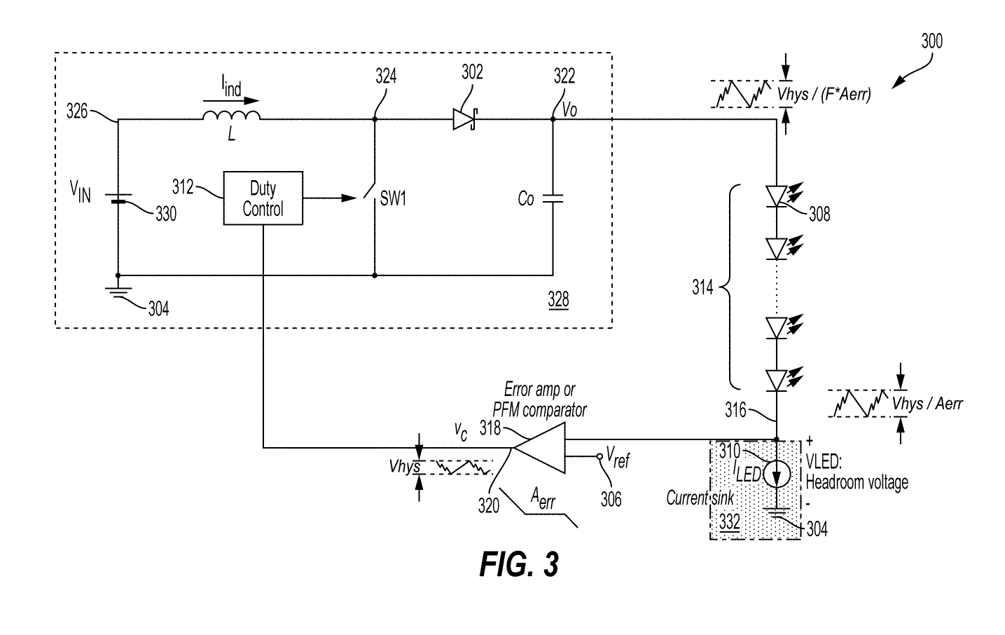

FIG. 3 is a schematic diagram of a boost control loop 300 for adaptively controlling a backlight boost converter of a backlight display device according to aspects of the present disclosure. While the boost control loop 300 illustrates pulse frequency modulation, the boost control loop may also be implemented in accordance with pulse width modulation and/or pulse skipping modulation. The boost control loop 300 includes an LCD backlight boost converter and surrounding circuitry 328, an LED string 314, which includes multiple LEDs 308, and a comparator 318. A current sink device 332 may be coupled to the LED string 314 and the comparator 318 of the boost control loop 300. The current sink device 332 may include a current driver 310 coupled to a ground 304.

The LCD backlight boost converter and surrounding circuitry 328 represent a power stage of the boost control loop 300. The LCD backlight boost converter and surrounding circuitry 328 include a first switching device SW1, a capacitor C_{O}, a second switching device 302 (or SW2), an inductor L, and an input voltage source 330 coupled to the ground 304. In some implementations, the first and the second switching devices SW1 and SW2 may be transistors (e.g., boost transistors). However, in this illustration, the second switching device SW2 is a diode, such as a Schottky diode, that prevents current to flow from an output to an input of the Schottky diode. The capacitor C_{O} is an output capacitor connected between the output voltage node 322 and the ground 304. The LED string 314 is an output load that is connected in parallel with the capacitor C_{O} between the output node 322 and the ground 304.

An input voltage V_{IN} is applied to an input voltage node 326. The input voltage V_{IN} may be supplied by the input voltage source 330 that is coupled to the input voltage node 326. The inductor L is connected between the node 326 and a node 324. A switch control device 312 (e.g., a duty cycle control device) may be included in the LCD backlight boost converter and surrounding circuitry 328 or be separate but coupled to the LCD backlight boost converter and surrounding circuitry 328. A control signal of the boost control loop 300 may be forwarded to the first switching device SW1 via the switch control device 312 and the comparator 320.

The LCD backlight boost converter and surrounding circuitry 328 may be included in a user equipment or other electronic device to provide a regulated power supply to system electronics (e.g., LCD display including multiple LED strings). The LCD backlight boost converter and surrounding circuitry 328 may operate in different modes including a boost mode. In the boost mode, the voltage V_{IN} at the input node 326 is boosted to produce the regulated voltage V_{O} at the output node 322. Thus, the output voltage V_{O} of the LCD backlight boost converter and surrounding circuitry 328 is a constant voltage and the input voltage V_{IN} (e.g., from the input voltage source 330) can be above or below the output voltage V_{O}. The input voltage source 330 may be a battery which charges and discharges during operation.

A minimum voltage across the current sink device 332 is specified to maintain proper LED current accuracy. This voltage (VLED) is referred to as the headroom voltage. For example, the headroom voltage is a voltage across the current sink device 332 between a node 316 and the ground 304. In conventional implementations, a loss of power associated with the headroom voltage V_{LED} is a static loss. The loss of power may be given by a product of the headroom voltage V_{LED} and a current I_{LED} of the current sink device 332. The boost control loop 300 may achieve efficiency by reducing the headroom voltage, which is determined by a boost reference voltage (V_{ref}) introduced in the boost control loop 300.

Lowering the headroom voltage V_{LED} of the current sink device 332, however, degrades the LED current accuracy. For example, accuracy of the LED current is degraded by insufficient headroom voltage which can cause the current sink device 332 or LED driver to be saturated. Thus, it is desirable to maintain a minimum headroom voltage (e.g., a predetermined minimum value) of the current sink device 332 to improve efficiency and accuracy. The LCD backlight boost converter and surrounding circuitry 328 are designed to provide a stable regulated output voltage rail (e.g., V_{O}) that accounts for the predetermined minimum value and a voltage drop across the LED string 314. For example, the LCD backlight boost converter and surrounding circuitry 328 support stable output voltage so that a difference between the output voltage V_{OUT} and a voltage drop across the LED string 314 is equal to the predetermined minimum value. In case of multiple LED strings in parallel, the headroom voltage of one LED string is regulated to be equal to the predetermined minimum value while the headroom voltage of the other LED strings is larger.

The output voltage V_{OUT} of the LCD backlight boost converter and surrounding circuitry 328 are sensitive to noise and boost output voltage ripple. Large output voltage ripple associated with the output voltage V_{OUT} causes audible noise with a ceramic capacitor (e.g., C_{O}). The audible noise increases at low brightness levels. For example, more than 100 mVpp (millivolts peak-to-peak) ripple causes audible noise. Moreover, large output ripple can affect current accuracy of the LEDs 308 because the headroom voltage V_{LED} of the current sink device 332 can be impaired or made undesirable by the ripple as the headroom voltage V_{LED} is reduced.

Various implementations are directed to creating a constant headroom voltage over all brightness levels of the LEDs 308. To improve the output voltage ripple, some implementations use high switching frequency at low brightness. However, these implementations have low efficiency. Other implementations adopt low pulse skipping modulation (PSM) or pulse frequency modulation (PFM) hysteresis. However, these implementations result in an increase in noise sensitivity. Additional implementations use a large output capacitance for filtering. However, these implementations increase cost or size of a bill of materials (BOM). Further implementations use automatic pulse width modulation (PWM)/PFM transition by load current detection in an analog domain. However, the design for such implementations is complicated.

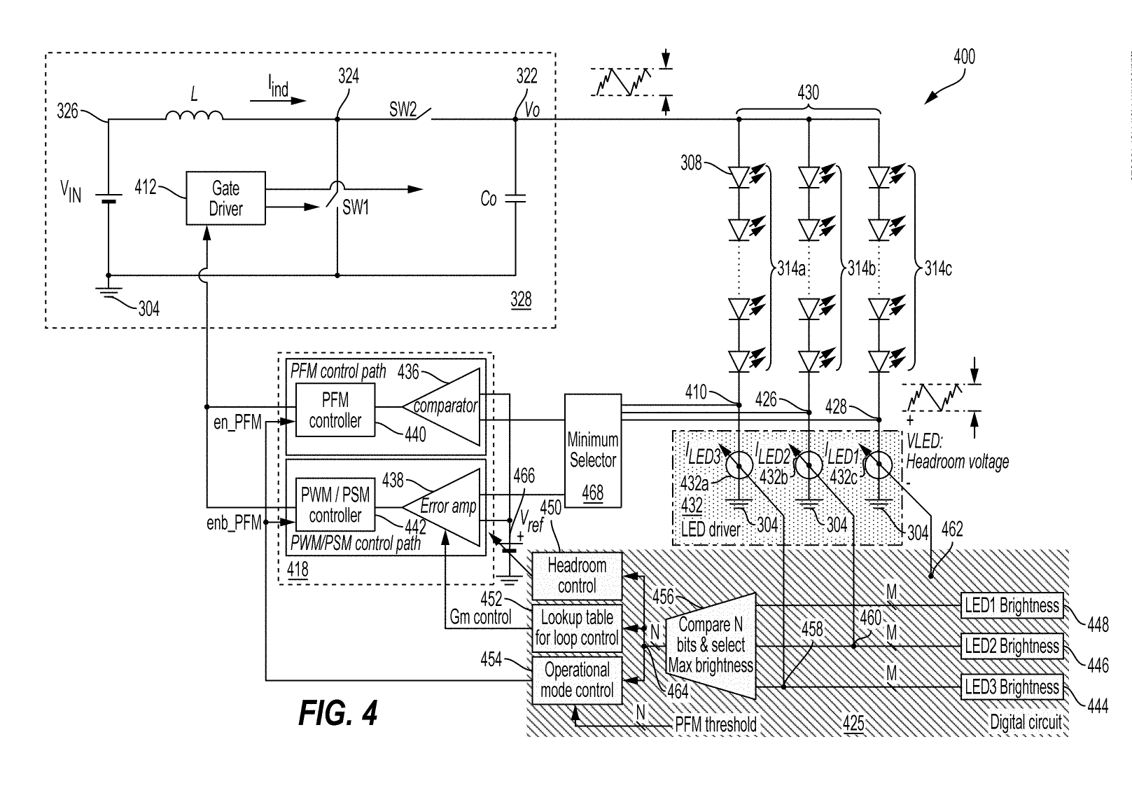

Aspects of the present disclosure are directed to reducing ripple and noise. The reduction may be based on a selection of brightness levels (e.g., increased or maximum brightness levels) of each of the LED strings. The brightness levels of each of the LED strings are independently programmed and used to control a boost reference voltage V_{REF} and to select a desirable boost operating mode and loop bandwidth in digital domain. For example, the headroom voltage of the current driver is adjusted based on the brightness settings of one or more LED strings. Similarly, the boost operating mode is adjusted based on the brightness settings of one or more of the LED strings regardless of input supply voltage. This adjustment indicates a digitally-assisted adaptive operational mode transition. Aspects of the present disclosure may be implemented in accordance with the boost control loop as illustrated in FIG. 4.

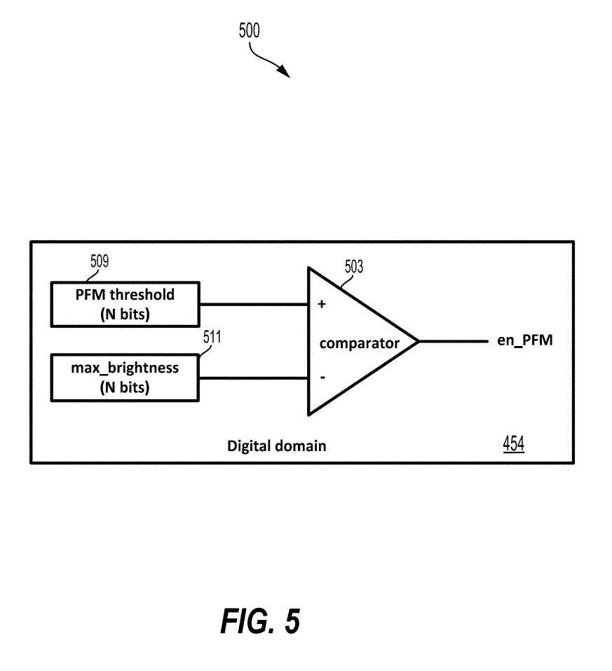

FIG. 4 is a schematic diagram of another boost control loop 400 for adaptively controlling a backlight boost converter of a backlight display device according to aspects of the present disclosure. For illustrative purposes, some of the labelling and numbering of the devices and features of FIG. 4 are similar to those of FIG. 5. In addition to the devices and features illustrated in FIG. 3, FIG. 4 illustrates an LCD display 430 that includes multiple LED strings, a current sink device 432, a controller or digital circuit 425, a modulation device 418, and a selection device 468. The multiple LED strings include a first LED string 314a, a second LED string 314b, and a third LED string 314c. Of course more or fewer LED strings can be present.

The current sink device 432 includes a first current sink device 432a, a second current sink device 432b, and a third current sink device 432c that are respectively positioned between nodes 410, 426, 428, and the ground 304. The first current sink device 432a, the second current sink device 432b, and the third current sink device 432c are respectively coupled to the first LED string 314a, the second LED string 314b, and the third LED string 314c. The digital circuit 425 includes a first LED brightness device 444, a second LED brightness device 446, a third LED brightness device 448, a first comparing device 456 (e.g., comparator), a headroom control device 450, a lookup table device 452 (e.g., memory), and an operational mode control device 454.

The modulation device 418 includes a PFM control device 440 and a second comparing device 436 (e.g., comparator) coupled to the PFM control device 440 in a PFM control path. The modulation device 418 also includes a PWM/PSM control device 442 and a third comparing device 438 coupled to the PWM/PSM control device 442 in a PWM/PSM control path.

An output of each of the LED brightness devices 444, 446, and 448 is coupled to the first comparing device 456 via their respective output nodes 458, 460, and 462. The output of each of the LED brightness devices 444, 446, and 448 is also respectively coupled to each of the first current sink device 432a, the second current sink device 432b, and the third current sink device 432c via their respective output nodes 458, 460, and 462. The first comparing device 456 is coupled to inputs of the headroom control device 450, the lookup table device 452, and the operational mode control device 454 via its output node 464.

An output of the headroom control device 450 is coupled to first inputs of the second comparing device 436 and the third comparing device 438 via a voltage reference source 466. The voltage reference source 466 may be an adjustable voltage reference source, in which a voltage output (boost reference voltage V_{REF}) to the second and third comparing devices 436 and 438 are adjusted based on a received signal from the headroom control device 450. An output of the lookup table device 452 may be coupled to the second comparing device 436 and/or the third comparing device 438.

The nodes 410, 426, and 428 between the LED strings and the current sink device 432 are coupled to inputs of the selection device 468. For example, the nodes 410, 426, and 428 are respectively coupled to the output of the first LED string 314a, the second LED string 314b, and the third LED string 314c. The voltages at the nodes 410, 426, and 428 respectively represent a voltage (V_{LED}) across the current sink devices 432a, 432b, and 432c. The selection device 468 provides an output to the second comparing device 436 and/or the third comparing device 438 depending on the control path being used.

In one aspect of the disclosure, loop control may be achieved with a lookup table and corresponding lookup table device 452. For example, an output of the lookup table device 452 may cause a transconductance of the third comparing device (error amplifier) 438 to be adjusted based on the brightness levels output from the LED brightness devices 444, 446 and 448. The lookup table may not affect the comparing device 436 (e.g., PFM comparator). The output of the operational mode control device 454 is coupled to the PFM control device 440 and/or the PWM/PSM control device 442. Each output of the PFM control device 440 and the PWM/PSM control device 442 is coupled to an input of the switch control device 412 (or gate driver). The output of the switch control device 412 is coupled to one or more of the transistors SW1 and SW2.

In one aspect of the present disclosure, an increased or maximum brightness level is dynamically selected in accordance with a digital domain implementation at the digital circuit 425. For example, the maximum brightness level corresponds to an increased brightness level of a load (e.g., the LCD display 430). In some aspects, the LED strings are arranged in a parallel configuration (as illustrated in FIG. 4 with respect to the first, second, and third LED strings 314a, 314b, and 314c). A brightness level of each of the LED strings 314a, 314b, and 314c may be independently selected. The independent selection may be achieved through independent devices associated with the LED strings 314a, 314b, and 314c.

For example, the first LED brightness device 444 selects or identifies a first current brightness level or expected brightness level of the first LED string 314a. The second LED brightness device 446 selects or identifies a second current brightness level or expected brightness level of the second LED string 314b. Similarly, the third LED brightness device 448 selects or identifies a third current brightness level or expected brightness level of the third LED string 314c. The brightness levels may be selected or identified dynamically during operation (e.g., voltage regulation). In some aspects, the identification or selection may be in response to an automatic adjustment (e.g., without user interaction) or in response to an adjustment of brightness levels by a user. The headroom voltage of the current sink devices 432a, 432b, and 432c may be independently adjusted in response to the independently selected brightness levels.

Each of the selected brightness levels may be represented as a brightness level parameter (e.g., a predetermined number of bits such as 16 bits) for each of the LED strings 314a, 314b, and 314c. The first comparing device 456 receives the first, second, and third brightness levels of the first LED brightness device 444, the second LED brightness device 446, and the third LED brightness device 448. The first comparing device 456 compares the respective brightness levels represented as brightness level parameters. In one aspect, to expedite the comparison process, the first comparing device 456 compares a subset of a brightness level parameter (e.g., 4 bits) of each of the LED strings and determines a desired subset parameter corresponding to the brightest LED string. The selected brightness level represents the highest (or a maximum brightness level) of the three brightness levels or an increased brightness level.

After selecting the desired parameter or subset of the brightness level parameter, the following techniques may be implemented to improve efficiency of the LCD backlight boost converter and surrounding circuitry 328. The techniques include an adaptive headroom control implementation, an adaptive operational mode implementation, and an adaptive loop bandwidth control implementation.

The adaptive headroom control implementation may be achieved with the headroom control device 450 and the voltage reference source 466, among others. The boost reference voltage V_{REF} from the voltage reference source 466 is adjusted based on the selected brightness level for the brightest LED string. For example, the adjusted boost reference voltage V_{REF}, introduced in the boost control loop 400, may be compared to a dynamically selected minimum headroom voltage (V_{LED}) associated with one of the LED strings. To select the minimum headroom voltage, the headroom voltage of each of the current sink devices 432a, 432b, and 432c is independently adjusted based on the independent brightness levels received from their respective LED brightness devices 444, 446, and 448. In one aspect, the adjusted minimum levels may correspond to the minimum headroom voltages discussed with respect to FIG. 3.

The selection device 468 compares each of the independently adjusted headroom voltages of the current sink devices 432a, 432b, and 432c and selects the smallest or minimum headroom voltage. It is to be noted that the LED string corresponding to the minimum headroom voltage may be different from the brightest LED string. This follows because the selection of the minimum headroom voltage is independent of the selection of the brightest LED string. The selection device 468 then forwards an output corresponding to the selected minimum headroom voltage to the second comparing device 436 and/or the third comparing device 438.

The second comparing device 436 and/or the third comparing device 438 compares the adjusted boost reference voltage V_{REF} to the selected minimum headroom voltage (V_{LED}) associated with one of the LED strings. The comparison at the second comparing device 436 and/or the third comparing device 438 depends on whether the boost control loop 400 is operating in accordance with PFM or PWM/PSM. A control signal resulting from the comparison at the second comparing device 436 or the third comparing device 438 may be used to achieve a desirable headroom voltage of the current sink devices associated with the LED strings to improve efficiency. The control signal may be forwarded to the switch control device 412 to control the switching devices SW1 and SW2. In some aspects, efficiency may be improved due to the independent adjustments and control configuration of the LED strings in the present disclosure relative to a fixed headroom voltage control of conventional implementations.

The digitally assisted adaptive loop bandwidth control implementation may be achieved with the lookup table device 452 and the second comparing device 436 and/or the third comparing device 438, among others. The second comparing device 436 may be a comparator while the third comparing device 438 may be an amplifier (e.g., a transconductance amplifier). For example, adaptive loop bandwidth control is applied (e.g., only) to the comparing device 438. In one aspect of the disclosure, a bandwidth of the boost control loop 400 may be adjusted based on a lookup table. Adjusting the bandwidth of the boost control loop 400 may be implemented by adjusting a transconductance value of the transconductance amplifier (e.g., the third comparing device 438). The adjustment may be based on the dynamically selected maximum brightness level. This adjustment follows because loop bandwidth changes proportionally to the transconductance (Gm) value of the transconductance amplifier.

The dynamically selected maximum brightness level is received by the lookup table device 452 from the first comparing device 456. The lookup table device 452 then outputs a control signal to the transconductance amplifier. For example, the transconductance value of the transconductance amplifier may be adjusted based on the control signal (e.g., a transconductance (Gm) control signal) from the digital circuit 425. In one aspect, the adaptive loop bandwidth control may be implemented in accordance with pulse skipping modulation (PSM) to reduce PSM ripple in the output voltage.

The lookup table device 452 may include a lookup table controller coupled to a lookup table (e.g., Table 1) stored in memory. The lookup table may include multiple brightness levels matched with corresponding transconductance values. In one aspect, the brightness levels may be grouped into ranges (e.g., 0-6.25%) of brightness levels. Brightness levels within a given range may be assigned a maximum brightness level. For example, a brightness level range of 0-6.25% is assigned a maximum brightness level of 0 and a transconductance value of 14. The transconductance value may correspond to the value to which the transconductance of the second comparing device 436 or the third comparing device 438 is adjusted based on the selected maximum brightness level.

For the lowest brightness level (e.g., 0-6.25% and corresponding maximum brightness level of 0), the loop bandwidth may be increased by increasing the transconductance value. Accordingly, the transconductance value for the lowest brightness level is matched with the highest transconductance value (14) in the lookup table. At higher brightness levels, the loop bandwidth is limited or reduced for stable operation because the PWM ripple associated with the higher brightness levels is small enough. For example, at a higher brightness level (e.g., 25%-31.25% and corresponding maximum brightness level of 4), the loop bandwidth may be reduced by decreasing the transconductance value. Accordingly, the transconductance value for the higher brightness level is matched with a lower transconductance value (10) in the lookup table.

FIG. 5 illustrates an operation mode control device 500 according to an aspect of the present disclosure. The digitally adaptive operational mode transition implementation may be achieved with the operational mode control device 454 or 500 and the PFM control device 440 and/or the third PWM/PSM control device 442, among others. The operation mode control device 500 includes a threshold device 509 (e.g., PFM threshold device), a brightness level indication device 511, and a fourth comparing device 503 (e.g., comparator). Outputs of the PFM threshold device 509 and the brightness level indication device 511 are coupled to separate inputs of the fourth comparing device 503. The fourth comparing device 503 generates an output signal (e.g., PFM enable/disable signals en_PFM and enb_PFM) to enable or disable an operating mode of the control loop.

Adaptive operational mode transition includes determining the operating mode of the LCD backlight boost converter. The modes of the LCD backlight boost converter include a high current driving mode (e.g., PWM/PSM) and low output ripple mode (e.g., PFM). The PFM threshold is compared in digital domain to the maximum brightness level at the fourth comparing device 503. For example, the high current driving mode is implemented when the maximum brightness level is greater than (or equal to) the PFM threshold.

Referring to Table 1, a transconductance value is maintained at a specified transconductance value when brightness levels and/or the matched maximum transconductance values are above or equal to a threshold. In one aspect of the disclosure, the increased or maximum brightness levels correspond to the selected brightness (which is a maximum relative to the other brightness levels of other LED strings of the multiple LED strings).

For example, for a maximum brightness level of 5 or above, the transconductance value is maintained at 9, as illustrated in Table 1. In other words, transconductance values with matching brightness levels above the threshold brightness level have a same clamped transconductance value. The transconductance value is clamped based on the threshold implementation to reduce or limit bandwidth. The comparison of the threshold to the maximum brightness level occurs in digital domain.

The PFM enable/disable signals en_PFM and enb_PFM may be forwarded to the PFM control device 440 and/or the PWM/PSM control device 442 to select the mode of operation. The high current driving mode corresponds to the PWM/PSM mode. However, when the maximum brightness level is less than (or equal to) the PFM threshold, the low output ripple mode, which corresponds to the PFM mode is selected.

Aspects of the present disclosure achieve adaptive headroom control for efficiency improvement. For example, headroom voltage of one or more current sink devices connected to the one or more LED strings may be adjusted based on the adjusted boost reference voltage introduced in the boost control loop.

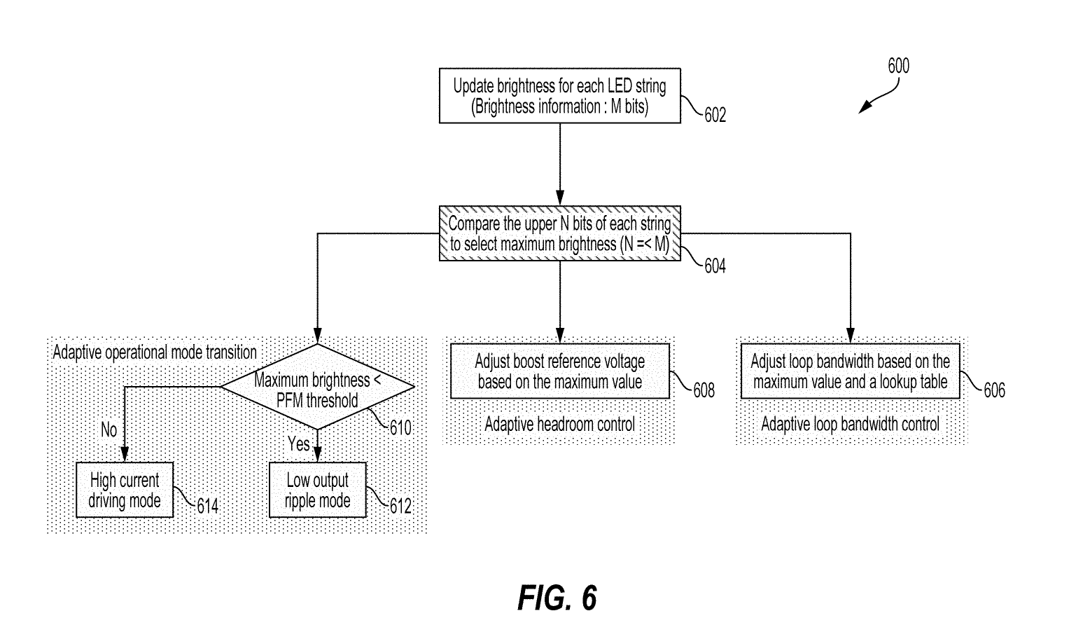

FIG. 6 depicts a simplified flowchart 600 of a method of controlling a boost converter according to one aspect of the present disclosure. The process starts at block 602 where a brightness level for each of the LED strings is updated or adjusted. The process continues to block 604 where a comparing device compares a subset of the brightness level parameter (e.g., upper N bits) of each of the LED strings and determines a desired subset parameter corresponding to the brightest LED string. The parameter is matched to its corresponding maximum brightness. For illustrative purposes, all of the techniques for improving efficiency of the LCD backlight boost converter and surrounding circuitry 328 branch off from block 604. However, these techniques can be implemented independently. For example, a selection process may be implemented to select use of a particular technique based on the operation conditions or applications as desired.

To improve PSM ripple based on the adaptive loop bandwidth control technique, the process continues to block 606 where the loop bandwidth is adjusted based on the maximum brightness and a lookup table. To improve efficiency based on the adaptive headroom control technique, the process continues to block 608 where the boost reference voltage is adjusted based on the maximum brightness value.

To further improve boost output ripple using the adaptive operational mode transition technique, the process continues to block 610 where it is determined whether the maximum brightness level is less than a PFM threshold. For example, adaptive operational mode transition improves the boost output ripple by using PFM at very low brightness because PFM has smaller ripple than PSM. When the maximum brightness level is less than the PFM threshold, the process continues to block 612 where a low output ripple mode of operation is selected. However, when the maximum brightness level is greater than or equal to the PFM threshold, the process continues to block 614 where a high current driving mode of operation is selected.

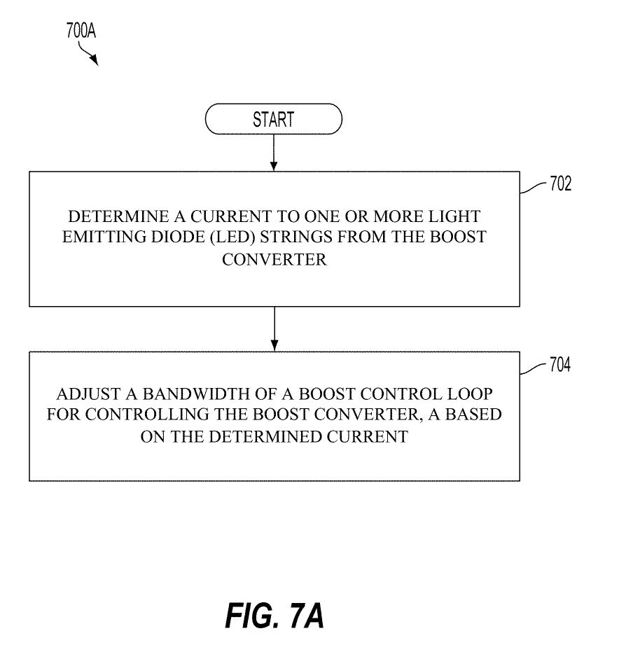

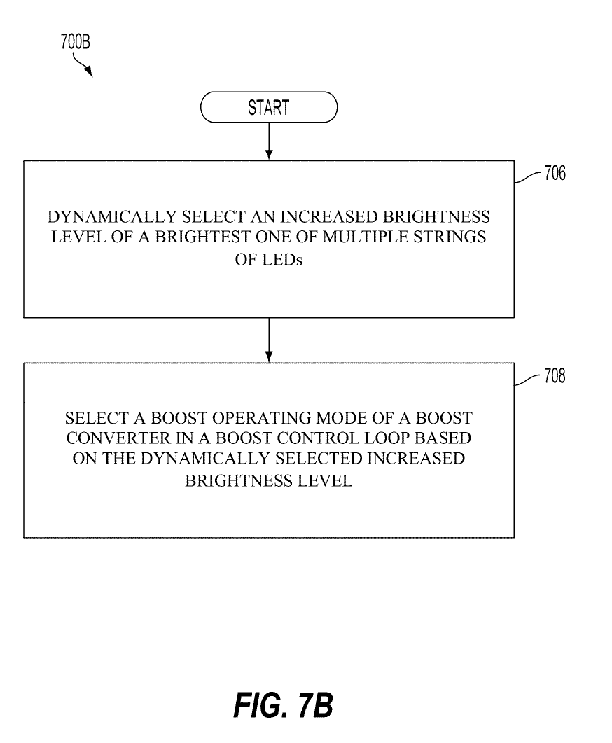

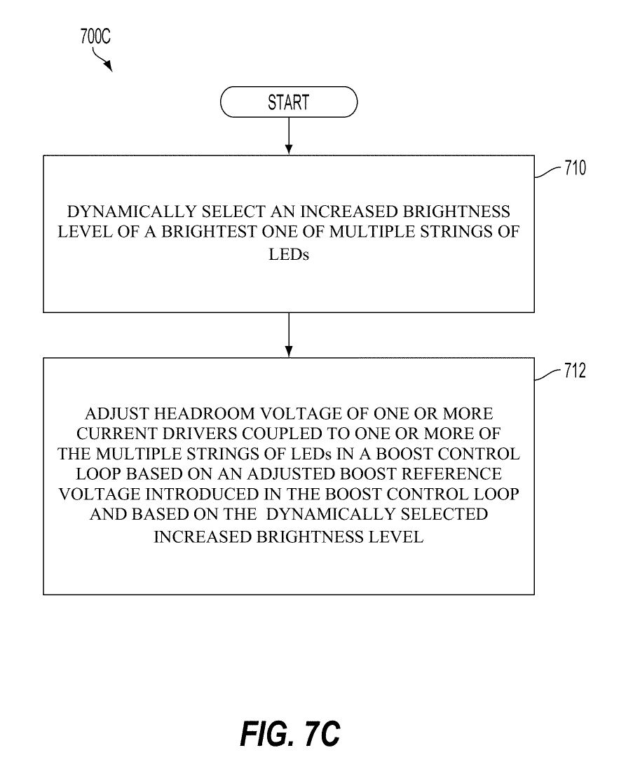

FIG. 7A depicts a simplified flowchart of a method 700A of controlling a boost converter, such as a display backlight boost converter, according to one aspect of the disclosure. At block 702, a current to one or more loads, e.g., LED strings, from the boost converter is determined. At block 704, a bandwidth of a boost control loop for controlling the boost converter based on the current is adjusted.

FIG. 7B depicts another simplified flowchart of a method 700B of controlling a boost converter, such as a display backlight boost converter, according to one aspect of the disclosure. At block 706, an increased (or maximum) brightness level of a brightest one of multiple strings of LEDs is dynamically selected. At block 708, a boost operating mode of a boost converter in a boost control loop is selected based on the dynamically selected increased brightness level.

FIG. 7C depicts another simplified flowchart of a method 700C of controlling a boost converter, such as a display backlight boost converter, according to one aspect of the disclosure. At block 710, an increased (or maximum) brightness level of a brightest one of multiple strings of LEDs is dynamically selected. At block 712, headroom voltage of one or more current drivers coupled to one or more of the strings of LEDs in a boost control loop is adjusted based on an adjusted boost reference voltage introduced in the boost control loop and based on the dynamically selected increased brightness level.

According to a further aspect of the present disclosure, a display backlight boost converter control system is described. The display backlight boost converter control system includes means for determining a current to at least one load from the boost converter. The current determining means may be the V_{OUT} control logic device 112, and/or the sensor logic device 110. The display backlight boost converter control system also includes means for adjusting a bandwidth of a boost control loop to control the boost converter based at least in part on the current. The adjusting means may be the V_{OUT} control logic device 112, and/or the sensor logic device 110. In another aspect, the aforementioned means may be any layer, module, or any apparatus configured to perform the functions recited by the aforementioned means.

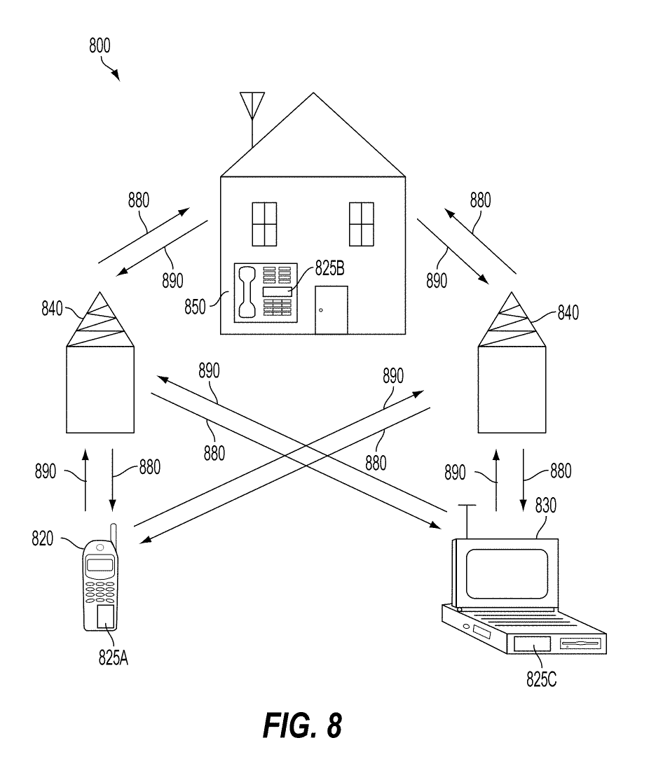

FIG. 8 is a block diagram showing an exemplary wireless communication system in which a configuration of the disclosure may be advantageously employed. For purposes of illustration, FIG. 8 shows three remote units 820, 830, and 850 and two base stations 840. It will be recognized that wireless communication systems may have many more remote units and base stations. Remote units 820, 830, and 850 include IC devices 825A, 825C, and 825B that include the disclosed display backlight boost converter control system. It will be recognized that other devices may also include the disclosed display backlight boost converter control system, such as the base stations, switching devices, and network equipment. FIG. 8 shows forward link signals 880 from the base station 840 to the remote units 820, 830, and 850 and reverse link signals 890 from the remote units 820, 830, and 850 to base station 840.

In FIG. 8, remote unit 820 is shown as a mobile telephone, remote unit 830 is shown as a portable computer, and remote unit 850 is shown as a fixed location remote unit in a wireless local loop system. For example, a remote units may be a mobile phone, a hand-held personal communication systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 8 illustrates remote units according to the aspects of the disclosure, the disclosure is not limited to these exemplary illustrated units. Aspects of the disclosure may be suitably employed in many devices, which include the disclosed display backlight boost converter control system.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic device, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

What is claimed is:

1. A method of controlling a boost converter comprising:
determining a current to at least one load from the boost converter; and
adjusting a bandwidth of a boost control loop to control the boost converter based at least in part on the current.

2. The method of claim 1, in which the at least one load comprises a plurality of strings of LEDs (light emitting diodes).

3. The method of claim 2, in which the current to the at least one load from the boost converter is representative of a brightness level of at least one of the plurality of strings of LEDs.

4. The method of claim 2, in which determining the current comprises determining current that is representative of a dynamically selected increased brightness level of a brightest one of the plurality of strings of LEDs.

5. The method of claim 2, further comprising selecting a boost operating mode of the boost converter based at least in part on a dynamically selected increased brightness level of at least one of the plurality of strings of LEDs.

6. The method of claim 5, in which the boost operating mode includes at least one of a high current driving mode and a low output ripple mode.

7. The method of claim 2, further comprising adjusting a boost reference voltage introduced in the boost control loop to control the boost converter based at least in part on a dynamically selected increased brightness level for at least one of the plurality of strings of LEDs.

8. The method of claim 7, further comprising adjusting headroom voltage of at least one current driver coupled to the at least one of the plurality of strings of LEDs based at least in part on the boost reference voltage that is adjusted.

9. The method of claim 1, in which adjusting the bandwidth of the boost control loop comprises adjusting a transconductance value of a transconductance amplifier in the boost control loop based at least in part on an increased current to a load.

10. The method of claim 9, further comprising selecting the transconductance value, which is adjusted, based at least in part on a lookup table including multiple brightness levels matched with corresponding transconductance values.

11. The method of claim 10, in which the corresponding transconductance values with matching brightness levels above a threshold brightness level have a same clamped transconductance value.

12. The method of claim 1, in which the current comprises an expected current.

13. An apparatus for wireless communication, comprising:
means for determining a current to at least one load from a boost converter; and
means for adjusting a bandwidth of a boost control loop to control the boost converter based at least in part on the current.

14. The apparatus of claim 13, in which the at least one load comprises a plurality of strings of LEDs (light emitting diodes).

15. The apparatus of claim 14, in which the current to the at least one load from the boost converter is representative of a brightness level of at least one of the plurality of strings of LEDs.

16. The apparatus of claim 15, in which the current determining means comprises means for determining current, which is representative of a dynamically selected increased brightness level of a brightest one of the plurality of strings of LEDs.

17. The apparatus of claim 15, further comprising means for selecting a boost operating mode of the boost converter based at least in part on a dynamically selected increased brightness level of at least one of the plurality of strings of LEDs.

18. An apparatus for wireless communication, comprising:
a memory; and
at least one processor coupled to the memory, the at least one processor configured:
to determine a current to at least one load from a boost converter; and
to adjust a bandwidth of a boost control loop to control the boost converter based at least in part on the current.

19. The apparatus of claim 18, in which the at least one load comprises a plurality of strings of LEDs (light emitting diodes).

20. The apparatus of claim 19, in which the current to the at least one load from the boost converter is representative of a brightness level of at least one of the plurality of strings of LEDs.

21. The apparatus of claim 19, in which the at least one processor is further configured to determine the current by determining current corresponding to a dynamically selected increased brightness level of a brightest one of the plurality of strings of LEDs.

22. The apparatus of claim 19, in which the at least one processor is further configured to select a boost operating mode of the boost converter based at least in part on a dynamically selected increased brightness level of at least one of the plurality of strings of LEDs.

23. The apparatus of claim 22, in which the boost operating mode includes at least one of a high current driving mode and a low output ripple mode.

24. The apparatus of claim 19, in which the at least one processor is further configured to adjust a boost reference voltage introduced in the boost control loop to control the boost converter based at least in part on a dynamically selected increased brightness level for at least one of the plurality of strings of LEDs.

25. The apparatus of claim 24, in which the at least one processor is further configured to adjust headroom voltage of at least one current driver coupled to the at least one of the plurality of strings of LEDs based at least in part on the boost reference voltage that is adjusted.

26. The apparatus of claim 18, in which the at least one processor is further configured to adjust the bandwidth of the boost control loop by adjusting a transconductance value of a transconductance amplifier in the boost control loop based at least in part on an increased current to a load.

27. The apparatus of claim 26, in which the at least one processor is further configured to select the transconductance value, which is adjusted, based at least in part on a lookup table including multiple brightness levels matched with corresponding transconductance values.

28. The apparatus of claim 27, in which the corresponding transconductance values with matching brightness levels above a threshold brightness level have a same clamped transconductance value.

29. The apparatus of claim 18, in which the current comprises an expected current.

30. A non-transitory computer-readable medium having program code recorded thereon which, when executed by processor(s), causes the processor(s):
to determine a current to at least one load from a boost converter; and
to adjust a bandwidth of a boost control loop to control the boost converter based at least in part on the current.
